(19) United States
(12) Patent Application Publication
(10) Pub. No.: US 2020/0114418 A1
(43) Pub. Date: Apr. 16, 2020

(54) METHOD AND APPARATUS FOR ALIGNING NOZZLES FOR DIE CASTING

(71) Applicant: Herco, LLC, Rochester Hills, MI (US)

(72) Inventor: Rainer Herrmann, Rochester Hills, MI (US)

(73) Assignee: Herco, LLC, Rochester Hills, MI (US)

(21) Appl. No.: 16/594,501

(22) Filed: Oct. 7, 2019

Related U.S. Application Data
(60) Provisional application No. 62/745,536, filed on Oct. 15, 2018.

(51) Int. Cl. B22D 17/20; B22D 17/32; B05B 15/68

(52) U.S. Cl. CPC B22D 17/2007; B05B 15/68; B22D 17/32

(57) ABSTRACT

A device and process for quickly and reliably determining and recording the configuration of multiple spray nozzles on a spray head assembly used for lubricating a die cast mold reduces trial and error associated with maintenance and repair of the spray head assembly. The device includes an adaptor configured to attach to a spray nozzle and an inertial measurement unit fixed to the adaptor to determine the orientation of the spray nozzle relative to a reference. The method involves using the device to determine the orientation of each of a plurality of spray nozzles on a spray head assembly relative to the reference and recording the relative orientation of each nozzle.

### CROSS-REFERENCE TO THE RELATED APPLICATION

This application claims priority to Provisional Application No. 62/745,536, filed Oct. 15, 2018 which is hereby incorporated by reference in its entirety.

### FIELD OF THE DISCLOSURE

This disclosure relates to die preparation for die casting processes, and more particularly to methods and devices for realigning lubricant spray nozzles after maintenance or repair involving dismantling of a die lubrication system.

### BACKGROUND OF THE DISCLOSURE

Die casting of relatively high-melting temperature alloys, such as aluminum or magnesium alloys, generally requires lubrication of the die surfaces that contact the molten metal and subsequently solidified casting to prevent reaction of the casting material with the die surfaces. In order to enable consistent production of high quality castings, it is highly desirable that the die lubrication system, which generally comprises a plurality of spray nozzles, consistently produces a precise spray pattern that completely coats the internal surfaces of the die defining the shape of the casting, without any significant over-application on surfaces which increases cycle time, and unnecessarily increases die lubricant consumption, and without any significant under-application on surfaces, which can result in inadequate release of the casting from the die and excessive scrap due to casting defects. Thus, considerable time and effort is invested in adjusting the alignment of spray nozzles in a die casting lubrication system. During the set-up of a new die casting machine considerable skill and experience is relied upon to make an informed guess as to how the lubrication spray nozzles should be aligned to facilitate production of high quality castings in the shortest cycle time with the minimum use of lubricant. A small production run (e.g., 25, 50, 100 castings) is used to determine what adjustments need to be made to the nozzle alignments. Appropriate adjustments are determined and made, and the process is repeated in a trial-and-error style until consistently good results are obtained.

Before maintenance of or repair to the die lubrication system, which typically involves disassembly of the nozzles and segments or fittings connecting the nozzles to a face plate or spray head (i.e., lubrication distribution manifold), the alignment of the nozzles is recorded to avoid repeating the substantial efforts that were needed to initially adjust the nozzle alignments to optimize production and minimize waste. A relatively sophisticated method involves three-dimensional (3D) scanning to produce a precise record of optimized nozzle alignments to reduce or eliminate trial-and-error during reassembly of the die lubrication system after maintenance or repair, which is typically required two or more times annually. However, 3D scanners are relatively expensive (typically about $100,000) and require highly skilled technicians to obtain reliable records. Such expenses are particularly undesirable for smaller production facilities.

A less sophisticated and much less expensive method of recording (or characterizing) optimum nozzle alignments involves attaching a laser pointer on each nozzle (typically sequentially) and recording the laser projection (such as with an ink marker) on a template (typically a flat sheet of cardboard, plywood, or the like) that is held at a predetermined distance from a reference point on the spray head and at a predetermined angular orientation relative to the spray head. For any particular system, a plurality of templates (e.g., six) are required to completely characterize the alignments of all nozzles on the spray head(s). The technician recording the nozzle alignments must meticulously mark each template with its orientation and distance from an identified reference point of the spray head and identify the appropriate nozzle corresponding with each laser projection that is marked on the templates. A disadvantage with this method of using templates and laser pointers is that there is a substantial risk of error involved in manually recording all required information on the templates. Additionally, there is a risk that the templates will be lost, misplaced or damaged between the time they are produced and the time they are needed for realignment of the nozzles after maintenance or repair is completed and the spray head is reassembled. Moreover, this method of recording nozzle alignments is not perfect and some experimentation (i.e., trials) may be needed to re-optimize the nozzle orientations after reassembly.

### SUMMARY OF THE DISCLOSURE

In certain aspects of this disclosure, a device for determining the orientation of a spray nozzle on a die casting lubrication spray head includes an adaptor that is configured to attach to a spray nozzle in a predetermined orientation or to a fitting on which a spray nozzle can be installed in a predetermined orientation, and an inertial measurement unit having a two- or three-axis gyroscope to determine an orientation of the device relative to a reference orientation. The inertial measurement unit is fixed relative to the adaptor. The device can be used to determine the spray axis of the nozzle relative to a reference orientation.

In certain aspects of this disclosure, a device for determining the position and orientation of a spray nozzle on a die casting lubrication spray head includes an adaptor that is configured to attach to a spray nozzle in a predetermined orientation or to a fitting on which a spray nozzle can be installed in a predetermined orientation, and an inertial measurement unit having a two- or three-axis gyroscope to determine an orientation of the device relative to a reference orientation and having a three axis accelerometer to determine position relative to a reference position. The inertial measurement unit is fixed relative to the adaptor. The device can be used to determine the spray axis of the nozzle and characteristic position of the nozzle relative to a reference orientation and reference position that can be defined with respect to the spray head.

In accordance with certain other aspects of this disclosure, a process is provided for determining and recording the orientations of multiple spray nozzles on a spray head, using an inertial measurement unit fixed to an adaptor that is configured to attach to a nozzle or fitting on which a nozzle is mounted to place the inertial measurement unit in a predetermined orientation indicative of the optimized orientation of the nozzle when it is installed on the spray head. The inertial measurement unit includes a two- or three-axis gyroscope to determine an orientation relative to a reference orientation.

Associated with the inertial measurement unit is a recorder and/or wireless communications device for storing the orientation indicative of the optimized orientation of the installed nozzle, or transmitting the orientation to a computer, cellular telephone or other device capable of receiving and storing digital information received via wireless communications. This process can be repeated for a plurality of nozzles on a spray head, and/or for multiple spray heads used on a single die casting fixture.

In accordance with certain other aspects of this disclosure, a process is provided for determining and recording the configurations (positions and orientations) of multiple spray nozzles on a spray head, using an inertial measurement unit fixed to an adaptor that is configured to attach to a nozzle or fitting on which a nozzle is mounted to place the inertial measurement unit in a predetermined orientation and predetermined position indicative of the optimized position and orientation of the nozzle when it is installed on the spray head. The inertial measurement unit includes a two- or three-axis gyroscope to determine an orientation relative to a reference orientation, and a three-axis accelerometer to determine position relative to a reference position. Associated with the inertial measurement unit is a recorder and/or wireless communications device for storing the position and orientation indicative of the optimized position and orientation of the installed nozzle, or transmitting the position and orientation to a computer, cellular telephone or other device capable of receiving and storing digital information received via wireless communications. This process can be repeated for a plurality of nozzles on a spray head, and/or for multiple spray heads used on a single die casting fixture.

In still other aspects of this disclosure, there is provided a process for servicing and reassembling a die lubrication spray system having at least one spray head with a plurality of spray nozzles such that the nozzles are precisely oriented and located after reassembly as they were before disassembly for servicing. This process includes using the previously described steps for determining and recording the orientations, and optionally positions, of spray nozzles on a spray head; disassembling the spray head; servicing the spray head, such as by cleaning, repairing or replacing components of the spray head as needed or desired; and reassembling the spray head while also adjusting the orientation of each nozzle to match the recorded orientation of each nozzle prior to disassembly of the spray head.

### BRIEF DESCRIPTION OF THE DRAWINGS

FIG. 1 is a schematic side view of a die casting mold and a die lubrication system for spraying precise quantities of lubricant on surfaces of the mold.

FIG. 2 is a side view of a combination of nozzle and apparatus for measuring nozzle position and orientation.

FIG. 3 is a side view of the combination of FIG. 2 with the apparatus and nozzle in proper registry for acquisition of position and orientation data.

FIG. 4 is a side view of an alternative combination of nozzle fitting and apparatus for measuring nozzle position and orientation data.

FIG. 5 is a side view of the combination of FIG. 4 with the apparatus and fitting in proper registry for acquisition of position and orientation data.

FIG. 6 is a schematic illustration of an electronics package used for acquiring and recording position and orientation data.

FIG. 7 is a process flow diagram for software or algorithm for obtaining and recording orientation and/or position data for the nozzles.

### DESCRIPTION OF THE PREFERRED EMBODIMENTS

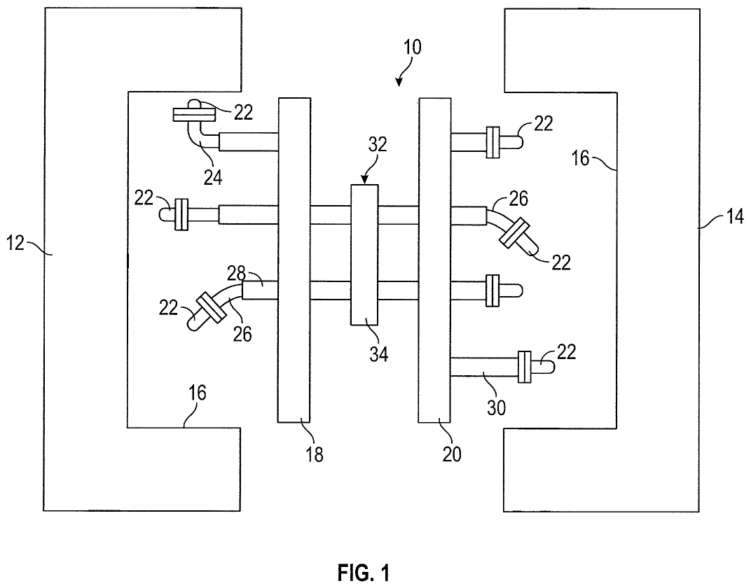

Shown in FIG. 1 is a drawing of a lubricating system 10 for a die casting apparatus comprising die mold segments 12, 14 having interior surfaces 16 that define the shape of an article that is to be cast. In the illustrated embodiment, the die comprises two mold segments, however, it is possible to design die casting molds having more than two segments. Also, in the illustrated embodiment, the lubricating system or spray head 10 includes two faceplates 18, 20 that serve as structure upon which spray nozzles 22 and associated segments or fittings are supported. Faceplates 18, 20 also function as manifolds for distributing lubricant and compressed air to the spray nozzles. For more complex die structures, more faceplates and/or more nozzles can be employed. For simpler die structures it is possible that fewer nozzles can be employed. Further, it is possible that only a single faceplate or manifold will be sufficient for certain types of die casting apparatus. For purposes of this disclosure and the appending claims, lubricating system or spray head refers to an apparatus that can be used for positioning a plurality of nozzles in a fixed orientation and position relative to die mold components to facilitate precisely reproducible lubricant coverage of the interior mold surfaces 16 before each of a multiplicity of die casting operations. Typically, the spray also comprises one or more manifolds for distributing compressed air and lubricant to the nozzles. Various fittings or segments can be employed for aligning the individual nozzles 22 to achieve optimum lubricant coverage of surfaces 16 to minimize lubricant use or waste while ensuring excellent release of the finished casting from the mold surfaces. For example, 90-degree elbows 24, 45-degree elbows 26, shorter-straight segments 28, and longer straight segments 30 may be used to adjust the position and orientation of a nozzle relative to a reference position and/or orientation relative to a reference. The nozzle position and/or orientation can be defined as desired provided that the definitions include a basis for reliably positioning or repositioning and reorienting the nozzles such as after reassembly following service. For example, nozzle position can be defined as the coordinates of the center point of the orifice at the tip of the nozzle relative to the reference position, and orientation can be defined as the set of angles quantifying the pitch, yaw and roll of the spray direction relative to the reference orientation, wherein the spray direction can, for example, be defined as a line coaxial with the length direction of the nozzle and passing through the center of the nozzle orifice. The reference position and orientation can be arbitrarily selected provided that it can be reliably and consistently fixed and determined relative to the mold segments, spray head, and/or other structure during lubrication of surfaces 16. For example, the reference point can be selected as point 32 centered at a top surface of faceplate support structure 34, and the reference orientation can be a line extending vertically upwardly from point 32. Position can be defined and measured using any convenient coordinate system, such as a Cartesian Coordinate system, preferably having three mutually orthogonal coordinate axes. Orientation of the nozzle can be defined as the angles between the reference axes and nozzle spray direction.

Once nozzles 22 have been optimally positioned and oriented to reduce cycle time, waste and scrap castings, a device 36 is used to determine and record these optimal positions and/or orientations for each nozzle relative to the reference position and reference orientation. The illustrated device 36 for determining and recording position and/or orientation of the nozzles includes an adaptor 38 that is configured to attach to or interface in registry with a spray nozzle 22 or to a fitting 40 on which the nozzle was installed, and an electronics package 42 that includes an inertial measurement unit that includes a two-axis or three-axis gyroscope 44 for determining an orientation of the spray nozzle relative to a reference orientation and optionally includes a three-axis accelerometer 46 for determining position of the spray nozzle relative to a reference position. Registry between the adaptor and the fitting or nozzle is achieved with conformal features that fit together in a single proper orientation and position of the adaptor with respect to the fitting or nozzle. The orientation angles and/or position coordinates can be displayed on a display device (e.g., LCD display) on package 42, recorded into a memory unit 50 for subsequent retrieval via a communication port 52 (e.g., USB port), and/or communicated to an external device (e.g., computer, tablet, portable cellular telephone, or other computing device) via a radio transmitter 54 (e.g., Bluetooth, WiFi, NFC, etc.) Various protocols and procedures can be used for recording the positions and/or orientations of the nozzles with respect to an established reference orientation and reference position. For example, if electronics package 42 includes display 48, the orientation angles and position coordinates for each nozzle can be manually recorded on an electronic or paper spreadsheet. As an alternative, a switch 56 can be manually closed to either transmit or record the angles and coordinates when the adaptor 38 is determined to be in proper registry with nozzle 22 or fitting 40. The nozzles can be labeled sequentially and position and/or orientation data for the nozzles can be recorded sequentially. Alternatively, software can be configured to allow manual entry or automated entry of nozzle identification, orientation and/or position. Nozzle identification can be entered automatically such as by providing package 42 with a camera 58 for reading a nozzle identification code 60 on a surface of the nozzle or fitting from which the nozzle was removed. It is also possible to provide device 36 with a switch 62 that is automatically closed by a protuberance 64 or other feature when the device 36 is in proper registry with the nozzle 22 or fitting 40 for determining and recording the orientation and position data for the nozzle.

In the case of a circular nozzle orifice, only two angles are needed to fully define or characterize the orientation of the nozzle. Accordingly, in those cases in which all of the nozzles 22 on a spray head 10 have a circular orifice, a two-axis gyroscope will suffice. However, in the more general case in which at least some of the nozzle orifices are non-circular (e.g., oval), it is desirable to employ a three-axis gyroscope so that a non-circular orifice is optimally rotated with respect to the spray direction.

The terms two- and three-axis gyroscope and three-axis accelerometer do not imply that all gyroscopic and/or acceleration detection devices are on the same chip (integrated circuit package). Rather, the requirements for two- and/or three-axis gyroscopes are that the electronics package 42 includes devices sufficient to detect rotations in two or three dimensions, respectively; and the requirements for a three-axis accelerometer are that package 42 includes devices sufficient to detect translation in all three dimensions.

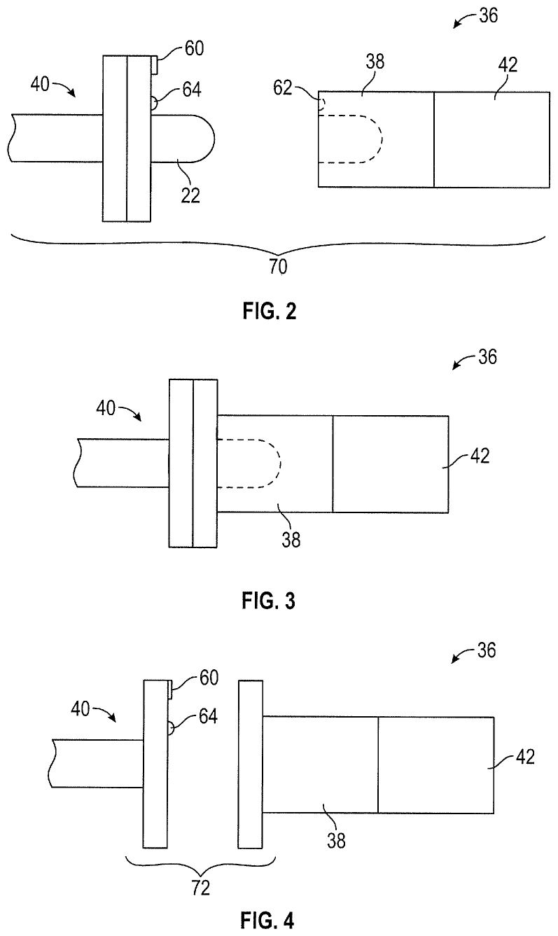

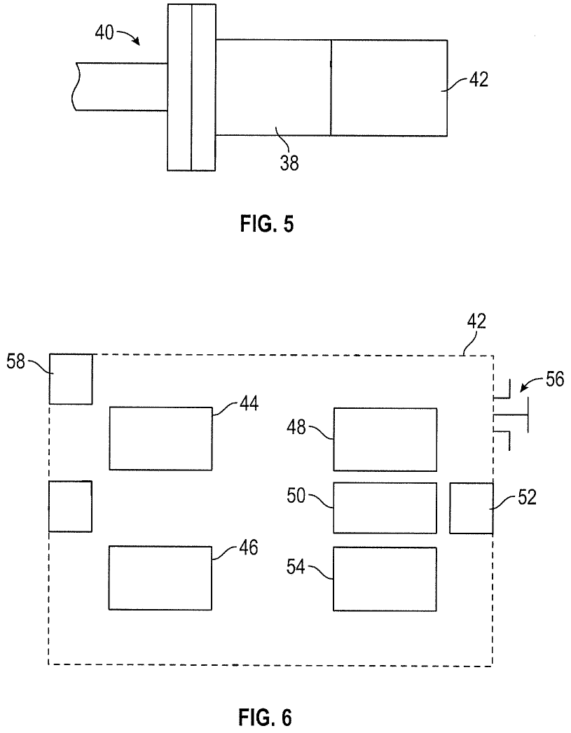

FIG. 2 shows a combination of nozzle 22 affixed to a fitting 40 (e.g., straight segment, elbow, etc.), and a device 36 for determining position and orientation, prior to establishing proper registry therebetween for collecting orientation and position data. In this case, device 36 is configured for registering with nozzle 22. A protuberance 64 or other feature can be employed as an indexing device that registers with a complementary feature 62 to ensure that the rotational angle of a non-circular orifice with respect to the spray direction is properly determined and recorded. Magnets, clamps, etc. (not shown) may be employed as desired to facilitate attachment of device 36 to nozzle 22 to facilitate acquisition of the position and orientation data. Alternatively, device 36 can be configured to interface with spray nozzle 22 to facilitate acquisition of nozzle orientation and/or position data without being physically attached to the nozzle. FIG. 3 shows the nozzle 22 and device 36 of FIG. 2 in proper registry for acquisition of the position and orientation data. FIG. 4 shows a combination 72 of nozzle 22 and device 36 in an alternative embodiment in which device 36 is configured to attach to the fitting or segment 40 on which nozzle 22 is to be installed. FIG. 5 shows the device 36 of FIG. 4 in proper registry with fitting 40 to facilitate acquisition of position and orientation data.

Electronics package 42 can also include one or more of a microprocessor or microcomputer 80 for controlling functional aspects of the device, an inertial measurement unit computer 82 for converting analog data from the gyroscopes and accelerometers into position and orientation data, power management circuitry 84, a battery 86, and a battery charger 88. A three-axis magnetometer 92 can also be employed in package 42 as a heading reference for obtaining more precise orientation and position data.

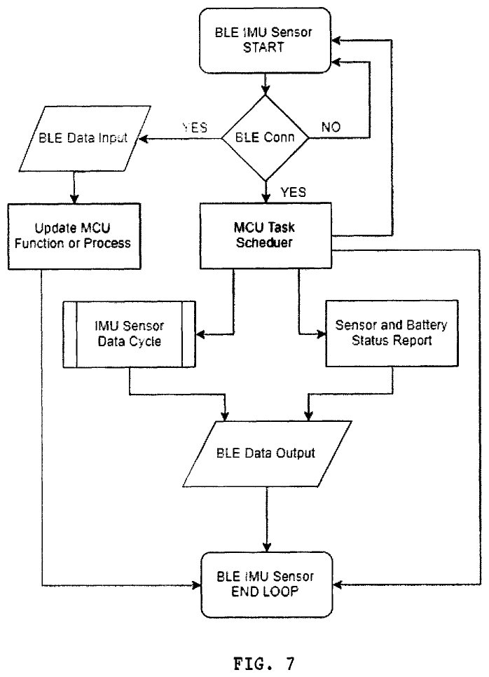

Shown in FIG. 7 is a logic diagram or algorithm for obtaining and recording orientation and/or position data. The process can start by detecting whether the device 36 is properly connected, or in proper registry, with a particular nozzle, and repeatedly restarting until proper registry or connection is detected. When proper registry or connection is detected, position and/or orientation data can be automatically measured and recorded to memory. Optionally, sensor status and battery status can be reported.

Accordingly, it is to be understood that the above description is intended to be illustrative and not restrictive. Many embodiments and applications other than the examples provided would be apparent upon reading the above description. The scope of the invention should be determined with reference to the appended claims along with the full scope of equivalents to which such claims are entitled. It is anticipated and intended that future developments will occur, and that the disclosed systems and methods will be incorporated into such future embodiments. In summary, it should be understood that the invention is capable of modification and variation.

What is claimed is:

1. A device for determining the orientation of spray nozzles on a die lubrication spray head relative to a reference position and orientation of the spray head, comprising:
an adaptor configured to interface in registry with a spray nozzle or fitting on which a nozzle can be installed; and
an inertial measurement unit fixed to the adaptor and having a two-axis or three-axis gyroscope to determine an orientation of the spray nozzle relative to a reference orientation.

2. The device of claim 1, wherein the inertial measurement unit is a part of an electronics package further comprising a memory unit for recording measured spray nozzle orientation.

3. The device of claim 1, wherein the inertial measurement unit is part of an electronics package further comprising a display device for displaying measured spray nozzle orientation.

4. The device of claim 2, wherein the electronics package includes a communication port for retrieval of data from the memory unit.

5. The device of claim 2, wherein the inertial measurement unit is a part of an electronics package including a radio transmitter for communication between the memory unit and an external device.

6. The device of claim 1, wherein the inertial measurement unit is a part of an electronics package further comprising a camera for determining an identification code of a spray nozzle.

7. The device of claim 2, wherein the electronics package includes a switch that is automatically activated when the device is properly registered with a spray nozzle to record the spray nozzle orientation.

8. The device of claim 1, wherein the inertial measurement unit further comprises a three-axis accelerometer to determine position of the spray nozzle relative to a reference position.

9. A process for determining and recording the configuration of multiple spray nozzles on a spray head, comprising:
using an inertial measurement unit having a two- or three-axis gyroscope to establish a reference orientation for the spray head;
using the inertial measurement unit to determine the orientation of each spray nozzle relative to the reference orientation; and
recording the relative orientation of each nozzle.

10. The process of claim 9, wherein the inertial measurement unit further comprises a three-axis accelerometer;
using the accelerometer to establish a reference position for the spray head; and
using the inertial measurement unit to determine the location of each spray nozzle relative to the reference position.

11. A process for servicing and reassembling a die lubrication spray system having at least one spray head with a plurality of spray nozzles such that the nozzles are precisely oriented and located after reassembly as before disassembly of the spray head, comprising:
establishing a reference orientation for the spray head;
using an inertial measurement unit to determine the orientation of each spray nozzle relative to the reference orientation;
recording the relative orientation of each nozzle;
disassembling the spray head;
optionally cleaning, repairing or replacing spray head components; and
reassembling the spray head and adjusting the orientation of each nozzle to match the recorded orientation.

12. The process of claim 11, wherein the inertial measurement unit further comprises a three-axis accelerometer;
using the accelerometer to establish a reference position for the spray head; and
using the inertial measurement unit to determine the location of each spray nozzle relative to the reference orientation and reference position.
